(19) United States
(12) Patent Application Publication
(10) Pub. No.: US 2024/0298653 A1
(43) Pub. Date: Sep. 12, 2024

(54) DOUGH PROCESSING SYSTEM WITH PRODUCT PROGRAM FORWARDING

(71) Applicant: FRITSCH BAKERY TECHNOLOGIES GMBH & CO. KG, Markt Einersheim (DE)

(72) Inventors: Wolfgang STEGMAIER, Dettelbach (DE); Samuel GEBHARDT, Kitzingen (DE)

(73) Assignee: FRITSCH BAKERY TECHNOLOGIES GMBH & CO. KG, Markt Einersheim (DE)

(21) Appl. No.: 18/597,840

(22) Filed: Mar. 6, 2024

(30) Foreign Application Priority Data
Mar. 7, 2023 (DE) 102023105536.4

(51) Int. Cl. A21C 14/00

(52) U.S. Cl. CPC A21C 14/00

(57) ABSTRACT

A dough processing system includes a plurality of processing sections arranged one behind the other in a production direction, which are configured to execute different product programs. The dough processing system comprises a control device connected to the processing sections for activating the product programs at the processing sections, and wherein a program change from a first product program respectively set thereon to at least one new, second product program can be activated. By activating the program change at the processing section arranged in first place in the production direction, the control device is prompted to automatically carry out the program change in successive steps at that processing section of the processing sections following in the production direction at a time at which, within this processing section, the processing of a preceding product format last processed in accordance with the first product program is deemed to have been completed.

### CROSS REFERENCE TO RELATED APPLICATIONS

This application claims foreign priority benefits under 35 U.S.C. § 119(a)-(d) to German patent application number DE 102023105536.4, filed Mar. 7, 2023, which is incorporated by reference in its entirety.

### TECHNICAL FIELD

The present disclosure relates to a dough processing system and to a method for automatically carrying out a program change on a dough processing system.

### BACKGROUND

Dough processing systems or industrial lines are known which are configured for the production of baked goods in industrial quantities. Such industrial lines have several processing sections in succession in the production direction in order to produce finished dough pieces from a dough material.

In particular, such industrial lines can be configured to produce different product formats. When changing from one product format to another product format, the respective processing sections used in the industrial line are usually set manually from section to section by the operating personnel to the new product format. In this process, new operating parameters are entered for each processing section. The control system is thus assigned new process parameters. These process parameters can be entered manually for each processing section using an input module of the control device.

However, such a program change carried out on each of the processing sections takes a lot of time, making the overall program change for the entire industrial line very time-consuming and leading to increased downtimes of the industrial line. In addition, specially trained skilled workers are needed to set the respective processing sections.

### SUMMARY

Against this background, an underlying problem of the disclosure is to provide a dough processing system or line and a corresponding method, making it easier to carry out a program change.

This problem is solved by means of a dough processing system according to the disclosure as well as by means of a method according to the disclosure.

The present disclosure relates to a dough processing system with a plurality of processing sections arranged one behind the other in the production direction, which are configured to execute different product programs for producing different product formats, wherein the dough processing system comprises a control device connected to the respective processing sections for activating the respective product programs at the processing sections. By means of this control device, a program change from a first product program set on the respective processing sections to at least one new, second product program can be activated.

According to the disclosure, it is provided that by activating the program change at the processing section arranged in first place in the production direction, the control device is configured to automatically carry out the program change in successive steps at that processing section of the processing sections following in the production direction at a time at which the processing of a product format last processed in accordance with the first product program is deemed to be completed within this processing section. This is the case when the end of the product format last processed in accordance with the first product program has left this processing section or has arrived in the processing section following in the production direction.

Such an automated and successive program change at the processing sections following the first processing section can significantly support the operating personnel in setting the dough processing system as a whole to a new product program. The fact that the newly activated product program is forwarded from processing station to processing station in the production direction in the disclosure means that there are only short downtimes of the industrial line, if any, due to tool changes.

In particular, the dough processing system according to the disclosure can be an industrial line the processing sections of which are configured for industrial bread production, industrial pastry production or industrial pizza and flatbread production. These industrial lines can be set to different product formats for the production of these product types.

In the automated program change function according to the disclosure, the activation of the program change at the processing section arranged in first place in the production direction serves as a trigger for the control device, so that the latter is prompted to adjust the other processing sections arranged downstream in the production direction in successive steps to the desired new second product program, in particular to reassign the respective processing sections by means of corresponding process parameters, so that tools used in the processing sections can be controlled accordingly, so that the industrial line as a whole automatically changes over to the new product program step by step.

Thus, the operating personnel is only required, if at all, to activate the program change at the processing section positioned in first place in the production direction, while further steps for carrying out the program change along the entire dough processing system can be carried out automatically. In the disclosure, the activation of the new product program or carrying out the program change at the processing section positioned in first place in the production direction thus serves to switch the control device to a changeover mode in which it automatically sets the following processing sections to the new product program step by step one after the other.

Preferably, the control device is configured to determine, on the basis of measured values of at least one approach circuit sensor assigned to the respective processing sections for detecting a beginning and/or an end of the product format moving into the processing sections and on the basis of a belt speed set for this product format at the processing sections, at which position the beginning and/or the end of the product format is located within the respective processing sections. Using the approach circuit sensors and the belt speeds, the control device can carry out dough tracking in order to precisely determine the position at which the beginning and/or end of the product format is located within the respective processing section.

According to a variant of the disclosure, the control unit is configured to determine the respective times at which the beginning of a product format first processed according to the second product program along the production direction reaches respective outputs of the processing sections arranged one behind the other, wherein the control device is prompted at these times to automatically carry out the program change at the processing section following the respective output if the processing of a product format preceding the product format first processed in accordance with the second product program and last processed in accordance with the first product program is deemed to be completed, or to delay the automatic program change at this processing station until the aforementioned condition is fulfilled there. Accordingly, when the beginning of the dough of the new product format reaches the next processing section, it is checked by the control device whether the end of the dough from the preceding product program has already left this processing section. This can be determined, for example, by means of the approach circuit sensor of the processing section positioned further downstream. As a result, the same measuring and evaluation technology can be used to determine the position of the end of the dough of the previous product format as is used to determine the position of the beginning of the dough of the subsequent, new product format.

It is conceivable that the control device is configured to determine the respective times at which the end of a product program last processed according to the first product program along the production direction reaches the respective inputs of the processing sections arranged one behind the other, wherein the control device is prompted at these times to automatically carry out the program change at the processing section preceding the respective input if the product format first processed in accordance with the second product program is present at the output of a processing section preceding this processing section, or to delay the automatic program change until the aforementioned condition is fulfilled at this preceding processing section. If this is the case, the new, second product program is also automatically activated in this processing section by means of the control device, i.e., loaded in it, whereby the respective process parameters for executing the new product program can be automatically stored in the control device for this processing section in order to automatically start the new product program in this processing section.

In particular, the processing sections form conveyor belt sections that can be controlled independently of each other, but are also suitable for coupled operation. This makes it possible to compensate for delays in the program change with regard to the delayed arrival of the beginning of the new product format at the output of the processing sections or with regard to the delayed arrival of the end of the product format preceding the new one at the input of the processing sections, even if the different product formats are conveyed along the dough processing system at different belt speeds.

Furthermore, the disclosure relates to a method for carrying out a program change on a dough processing system, wherein a control device activates a program change at a first processing section of the dough processing system connected thereto and mounted in first place in the production direction, from a first product program set thereon to a new, second product program. According to the disclosure, activating the program change at the processing section arranged in first place in the production direction prompts the control device to automatically carry out the program change in successive steps at the processing section of the subsequent processing sections in the production direction at a time at which the processing of the preceding product format last processed in accordance with the first product program is deemed to have been completed within this processing section. Consequently, by activating the program change on the processing section arranged in first place in the production direction, the control device can be switched to an automated change mode, by means of which it gradually carries out a product program adjustment on the subsequent processing sections without the need for further inputs on the control device by the operating personnel.

The processing sections following the first processing section are thus automatically set to the new product program one after the other, i.e., assigned corresponding process parameters, in order to change the operation running on them to the new, second product program in accordance with the preset, first product program.

Preferably, the control device determines at which position the beginning and/or the end of the product format is located within the respective processing sections on the basis of measured values from at least one approach circuit sensor arranged in the respective processing sections for detecting a beginning and/or an end of the product format moving into the processing sections and on the basis of a belt speed set for this product format at the processing sections. The measurement technology used in this respect can therefore be used to track the beginning and end of a product format.

One variant provides that the control device determines the respective times at which the beginning of a product format first processed in accordance with the second product program reaches respective outputs of the successively arranged processing sections along the production direction, wherein the control device is prompted at these times to automatically carry out the program change at the processing section following the respective output, if the processing of a product format preceding the product format first processed in accordance with the second product program and last processed in accordance with the first product program is deemed to be completed at this processing section, or to delay the automatic program change at this processing section until the aforementioned condition is fulfilled at this processing section. If the end is already out of the processing section, i.e., has reached the input of the subsequent processing section, the automatic program change can take place. Otherwise, this is delayed until the end of the last product format produced according to the first product program has reached the input of the subsequent processing section.

One embodiment of the disclosure provides that the control device determines the respective times at which the end of a product format last processed according to the first product program along the production direction reaches respective inputs of the successively processed working sections, wherein the control device is prompted at these times to automatically carry out the program change at the processing section preceding the respective input if the beginning of the product format first processed in accordance with the second product program is present at the output of a processing section preceding this processing section, or to delay the automatic program change until the aforementioned condition is fulfilled at this preceding processing section. This means that the program changes are carried out at the respective processing stations at the time when the beginning of the dough of the new product format arrives at their input, i.e., just in time.

In particular, the processing sections form conveyor belt sections positioned one behind the other, which are driven independently of each other, but can also be driven together, at least during the program change mode. This makes it possible to compensate for delays in the program change with regard to the late arrival of the beginning of the new product format at the output of the processing sections or with regard to the late arrival of the end of the product format preceding the new product format at the input of the processing sections, even if the different product formats are conveyed along the dough processing system at different belt speeds.

### BRIEF DESCRIPTION OF THE DRAWINGS

Embodiments of the disclosure are explained in more detail with reference to the following drawings:

FIG. 1 shows a schematic view of a dough processing system with three processing sections;

FIG. 2a shows a schematic view of a time-delayed program change on a dough processing system according to FIG. 1;

FIG. 2b shows another schematically shown, time-delayed program change on a dough processing system according to FIG. 1;

FIGS. 3a to 3e show a schematic view of a dough processing system as an industrial line with several processing sections and program changes that take place step by step one after the other; and

FIG. 4 shows a schematic diagram of a dough processing system in the form of an industrial line.

Identical technical features are provided with the same reference signs throughout the Figures.

### DETAILED DESCRIPTION

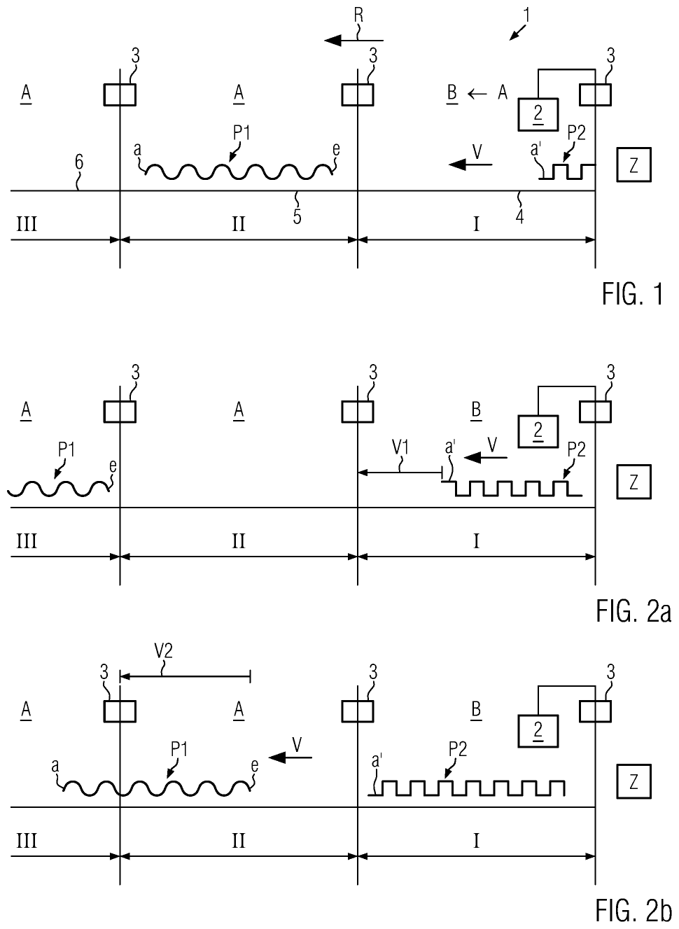

FIG. 1 shows a schematic view of a dough processing system 1 configured as an industrial line. The dough processing system 1 has a first processing section I positioned in first place in the production direction R. The first processing section I is followed by a second processing section II in the production direction R. Further downstream, i.e., behind the second processing section II, a third processing section III is shown schematically.

The dough processing system 1 of FIG. 1 also has a control device 2, which has the task of controlling and monitoring the respective processes at the processing sections I-III. Approach circuit sensors 3 positioned at the respective inputs of the processing sections I-III are connected to the control device 2, by means of which a beginning a and an end e of a product format P1, which is produced by means of a first product program A, can be detected. In particular, the respective approach circuit sensors 3 can detect the beginning a of the product format P1 by the fact that it arrives at the output of a processing section I-III or the end e of the product format P1 by the fact that it arrives at the input of one of the processing sections I-III.

According to FIG. 1, the second and third processing sections II, III are still set up for the first product program A. This means that the control device 2 controls these processing sections II, III according to the process parameters set for the first product program A.

Furthermore, FIG. 1 shows that the first processing section I positioned in first place is set from the first product program A to a new, second product program B in order to produce a new product format P2. For this purpose, the operating personnel of the dough processing system 1 selects the new product program P2 stored in a product program management system on the control device 2, which is then activated on the first processing section I when the end e of the product format P1 last produced by means of the first product program A has reached the input of the next, second processing section II. The control device 2 is thus set to a program change mode, which provides an automated program change function for the processing sections II, III following in the production direction R.

FIG. 2a shows that the end of the product format P1 last produced by means of the first product program A has arrived at the input of the third processing section III. At this time, however, a beginning a′ of the product format P2 produced by means of the newly selected product program B has not yet reached the output of the first processing section I. However, based on the detected measured values at the input of the first processing section I by means of the approach circuit sensor 3 and based on the belt speed v set in the first processing section I for the new product program B, the control device can predict or determine the time at which the beginning a′ of the new product format P2 will arrive at the output of the first processing section I. Until this occurs, the automatic program change is delayed at the subsequent second processing section II, which is schematically shown by delay V1.

According to the mode of operation shown schematically in FIG. 2a, the program change from the first product program A to the new product program B carried out at the second processing section II by the control device 2 is therefore delayed until, on the one hand, the end of the first product format P1 is present at the input of the third processing section III and the beginning a′ of the new product format P2 has arrived at the output of the first processing section I. Until the latter condition occurs, the preceding product format P1 can continue to be transported without interruption, possibly even at a different speed than the new product format P2.

FIG. 2b shows that due to the program change at the first processing section I from product program A to the new product program B, the beginning a′ of the new product program P2 has already reached the output of the first processing section I before the end of the preceding product format P1, which was last produced by means of the first product program A, has left the second processing section II. The control device 2 can detect this situation using the approach circuit sensors 3 and the respective belt speeds v and delay the program change at the second processing section II until the end e of the product program P1 has arrived at the input of the third processing section III, i.e., has left the second processing section II. For this purpose, a conveyor belt section 4 of the first processing section I stops, while conveyor belt sections 5, 6 of the two following processing sections II, III continue to run in order to transport the product format P1 out of the second processing section II so that the automated program change to the new product format P2 can be carried out.

According to FIG. 2b, the program change within the second processing section II is therefore delayed by the end e of the product format P1 last produced using the first product program A, which can still be detected therein. This delay is indicated schematically by the reference sign V2.

FIGS. 2a and 2b show schematically that the control device 2 of the dough processing system 1 detects the position of both the end e of the product format P1 and the beginning a′ of the product format P2 by means of dough tracking, so that in this respect the program change from the first product program A to the new product program B, which is carried out automatically in the second processing section II, always takes place when the end of the product format P1 is already in the third processing section III and the beginning of the new product format P2 has arrived before the input of the second processing section II.

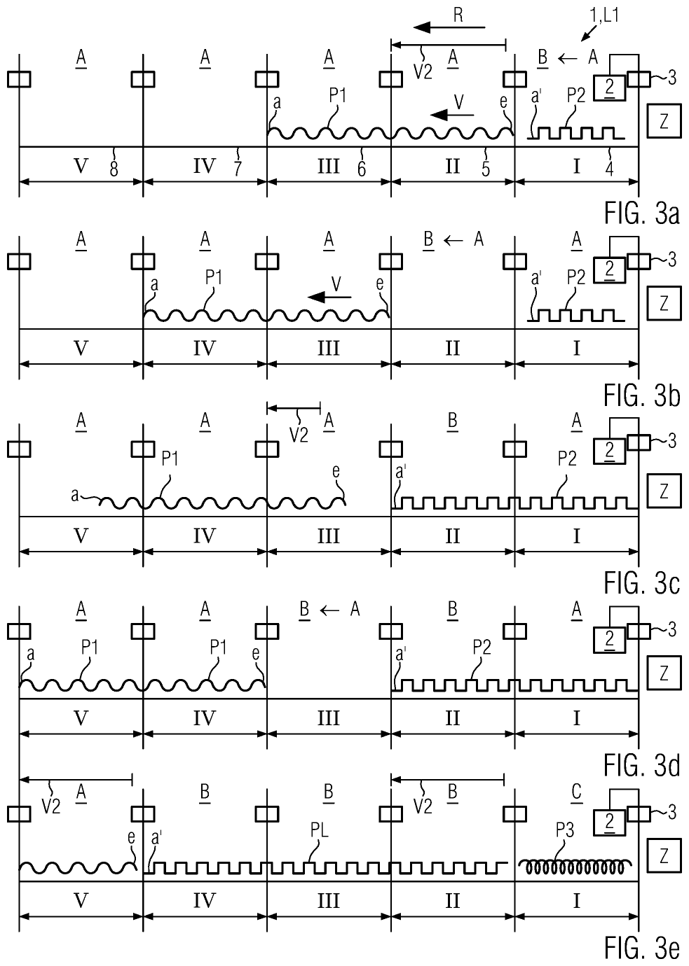

FIGS. 3a to 3e show the dough processing system 1 as an industrial line L1 with five schematically depicted processing sections I to V, which are connected by conveyor belt sections 4-8. At the first processing station I, a program change from a product program A to a new product program B has already taken place. This activated program change by means of the control device 2 now prompts the subsequent processing sections II to V to change from product program A to the new product program B step by step. This automatic sequence of program changes in the processing sections II to V is shown schematically in FIGS. 3b to 3e.

According to FIG. 3a, the beginning a′ of the new product format P2 has already arrived at the output of the first processing section I. However, the end e of the previous product format P1, which was last produced by means of the first product program A, has not yet left the subsequent second processing section II. For the automated program change at the second processing section II, the control device 2 now waits as long as it takes for the end e of the product format P1 to arrive at the input of the third processing section III. This creates a gap between the product format P1 and the new product format P2, i.e., the second processing section II is emptied. This is shown schematically in FIG. 3b. According to FIG. 3b, the second processing section II can then also be automatically set to the new product program B by the control device 2.

According to FIG. 3c, the beginning a′ of the new product format P2 has arrived at the output of the second processing section II, while the end e of the preceding product format P1 has not yet left the third processing section III. This means that the feeding of the new product format P2 stops until the end of the previous product format P1 has arrived in the fourth processing section IV, i.e., is present there at the input. This state is shown schematically in FIG. 3d, so that, as it has run empty, the third processing section III can now also switch from the original product program A to the new product program B. This is again carried out automatically by the control device 2, so that all process parameters for running the new product program B are now also preferably activated on the third processing section III.

Thus, the processing sections II to V arranged one behind the other can be automatically set to the new product program B step by step by means of the control device 2, without the operating personnel having to make settings for the respective processing sections II to V on the control device 2.

According to FIGS. 3a to 3e, the conveyor belt 4 has several conveyor belt sections 4 to 8 arranged one behind the other, which can be controlled by the control device 2 for independent or coupled operation with regard to the respective delays V2. For example, with regard to FIG. 3a, the conveyor belt sections 5 to 8 of the processing sections II to V would be driven together at the speed v in order to convey the end e of the product format P1 out of the second processing section II so that the program change from product program A to product program B can take place therein. While the respective conveyor belt sections 5 to 8 of the respective processing sections II to V are driven together, the conveyor belt section 4 of the first processing section I, which is positioned in first place, stops. This results in the situation shown in FIG. 3b, in which the second processing section II is completely free, which automatically triggers the automated program change from product program A to product program B.

According to FIG. 3c, the respective conveyor belt sections 4, 5 of the two processing sections I and II stop, while the conveyor belt sections 6, 7, 8 of the processing sections III to V arranged behind them are driven together to convey the end e of the product format P1 out of the third processing section III. This situation is shown in FIG. 3d, according to which the third processing section III has run empty now and can therefore be set to the new product program B.

In FIG. 3c, the conveyor belt sections 4 to 7 of the processing sections I to IV stop so that the conveyor belt section 8 of the fifth processing section V can continue transporting the end e of the product format P1, and the program change to the product program B takes place at the fifth processing section V when the conveyor belt section 8 provided therein has run empty. Conveyor belt sections 2 to 4 then move on, conveyor belt section 1 stops until conveyor belt section 2 has run empty. Once this is achieved, the second processing section II is switched from product format P2 to a new product format P3 and so on.

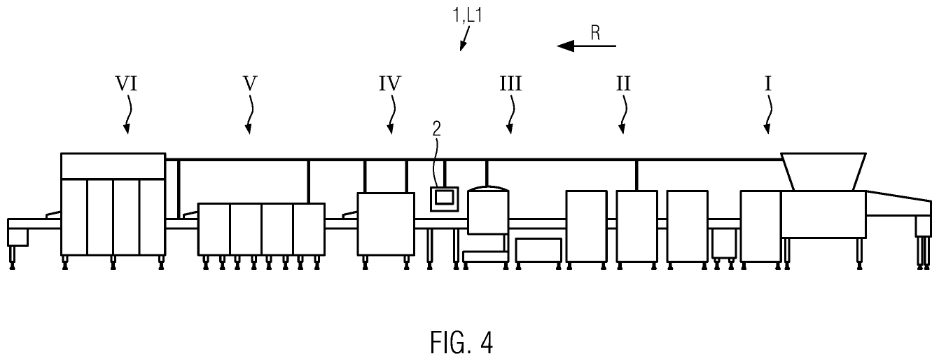

FIG. 4 shows a dough processing system 1, which is configured in the form of an industrial line L1 and has several processing sections I to VI arranged one behind the other in the production direction R for industrial bread production. The first processing section I, positioned in first place in the production direction R, is configured as a dough band former. Next, dough layers supplied in portions are formed into a dough strip therein. This is done by means of satellite heads which are mounted rotatably in the second processing section II and which allow the dough layers to be rolled out into a flat dough strip. In the third processing section III, positioned downstream in the production direction R, the dough strip is cut into tracks. These can be, for example, three dough tracks running parallel to each other, which are then brought to the desired distance from each other in the fourth processing section IV.

The subsequent fifth processing section V is configured as a punching device for punching out bread portions one after the other from the dough tracks fed in. Further downstream in the production direction R, a sixth processing section VI is positioned, which has a round molding tool, for example, to bring square-cut bread portions into a round bread shape.

The dough processing system 1 shown in FIG. 4 also has a control device 2 which is functionally connected to the respective processing sections I to VI. A program change activated on it causes the dough layer feed to be stopped and it is waited until the end of a product format previously produced in the first processing section I has left this processing section I. If this is the case, the first processing section I is changed to the new product program activated in the control device 2. This initiates an automation function, i.e., an automatic changeover mode in the control device 2, which leads to the respective subsequent processing sections II to VI being set to the new product program step by step one after the other. This always takes place when the end of the preceding product format, last produced by means of the previous product program, has left the respective processing sections II to VI and the beginning of the new product format has arrived at the input of these processing sections II to VI.

As one skilled in the art would understand, the control device 2, the approach circuit sensors 3, the processing sections, as well an any other control, controller, control system, unit, element, sensor, device, component, system, subsystem, arrangement, or the like described herein may individually, collectively, or in any combination comprise appropriate circuitry, such as one or more appropriately programmed processors (e.g. one or more microprocessors including central processing units (CPU)) and associated memory, which may include stored operating system software and/or application software executable by the processor(s) for controlling operation thereof and/or for performing the particular algorithms represented by the various functions and/or operations described herein, including interaction and/or cooperation between any such control device, sensor(s), processing section(s), control, controller, control system, unit, element, sensor, device, component, system, subsystem, arrangement, or the like. One or more of such processors, as well as other circuitry and/or hardware, may be included in a single ASIC (Application-Specific Integrated Circuitry), or several processors and various circuitry and/or hardware may be distributed among several separate components, whether individually packaged or assembled into a SoC (System-on-a-Chip).

What is claimed is:

1. A dough processing system comprising a plurality of processing sections arranged one behind the other in a production direction, which are configured to execute different product programs for producing different product formats, and a control device connected to the processing sections for activating the product programs at the processing sections, and wherein a program change from a first product program respectively set thereon to a new, second product program can be activated at the processing sections by the control device, wherein, by activating the program change at the processing section arranged in first place in the production direction, the control device is configured to automatically carry out the program change in successive steps at each respective processing section of the processing sections following in the production direction at a time at which, within the respective processing section, processing of a product format last processed in accordance with the first product program is deemed to be completed.

2. The dough processing system according to claim 1, wherein the control device is configured to determine, based on measured values of at least one approach circuit sensor assigned to the processing sections for detecting a beginning and/or an end of a product format of the product formats moving into the processing sections and based on a belt speed set for this product format at the processing sections, at which point the beginning and/or the end of the product format is located within a respective processing section of the processing sections.

3. The dough processing system according to claim 2, wherein the at least one approach circuit sensor comprises at least one approach circuit sensor assigned to each of the processing sections.

4. The dough processing system according to claim 2, wherein the control device is configured to determine respective times at which the beginning of a product format first processed according to the second product program along the production direction reaches respective outputs of the processing sections arranged one behind the other, wherein the control device is prompted at these times to automatically carry out the program change at the processing section following the respective output if the processing of a product format preceding the product format first processed in accordance with the second product program and last processed in accordance with the first product program is deemed to be completed at this processing section, or to delay the automatic program change at this processing section until the aforementioned condition is fulfilled at this processing section.

5. The dough processing system according to claim 2, wherein the control device is configured to determine respective times at which the end of a product format last processed according to the first product program along the production direction reaches respective inputs of the processing sections arranged one behind the other, wherein the control device is prompted at these times to carry out the program change automatically at the processing section preceding the respective input if the product format processed first in accordance with the second product program is present at an output of one of the processing sections preceding this processing section, or to delay the automatic program change until the aforementioned condition is fulfilled at this preceding processing section.

6. A method for automatically carrying out a program change on a dough processing system, the method comprising:
activating, by a control device, a program change from a first product program set on the dough processing system to a new, second product program on a first processing section of the dough processing system connected to the control device and mounted in first place in a production direction, wherein by activating the program change at the processing section arranged in first place in the production direction, the control device is prompted to automatically carry out the program change in successive steps at each respective processing section of the processing sections following in the production direction at a time at which, within the respective processing section, processing of a preceding product format last processed in accordance with the first product program is deemed to have been completed.

7. The method according to claim 6, wherein the control device determines, based on measured values of at least one approach circuit sensor assigned to the processing sections for detecting a beginning and/or an end of a product format of the product formats and based on a belt speed set for this product format at the processing sections, a position at which the beginning and/or the end of the product format is located within a respective processing section of the processing sections.

8. The method according to claim 7, wherein the at least one approach circuit sensor comprises at least one approach circuit sensor assigned to each of the processing sections.

9. The method according to claim 7, wherein the control device determines respective times at which the beginning of a product format first processed according to the second product program along the production direction reaches respective outputs of the processing sections arranged one behind the other, wherein the control device is prompted at these times to automatically carry out the program change at the processing section following the respective output if the processing of a product format preceding the product format first processed in accordance with the second product program and last processed in accordance with the first product program is deemed to have been completed at this processing section, or to delay the automatic program change at this processing section until the aforementioned condition is fulfilled at this processing section.

10. The method according to claim 7, wherein the control device determines respective times at which the end of a product format last processed according to the first product program along the production direction reaches respective inputs of the processing sections arranged one behind the other, wherein the control device is prompted at these times to automatically carry out the program change at the processing section preceding the respective input if the beginning of the product format first processed in accordance with the second product program is present at an output of a processing section preceding this processing section, or to delay the automatic program change until the aforementioned condition is fulfilled at this preceding processing section.
